(19) United States
(12) Patent Application Publication
(10) Pub. No.: US 2003/0200617 A1
(43) Pub. Date: Oct. 30, 2003

(54) Paint roller apparatus with rigid member and brush

(76) Inventor: Christopher Matthew Pyles, San Diego, CA (US)

Correspondence Address: Christopher M. Pyles, 9340 Hillery Dr. #4202, San Diego, CA, 92126, US

(21) Appl. No.: 10/419,623

(22) Filed: Apr. 23, 2003

Related U.S. Application Data
(63) Continuation-in-part of application No. 10/126,157, filed on Apr. 20, 2002.
(63) Continuation-in-part of application No. 10/271,456, filed on Oct. 15, 2002.

(51) Int. Cl. B05C 17/02

(52) U.S. Cl. 15/114; 15/230.11

(57) ABSTRACT

A paint roller apparatus with rigid member and brush facilitating the painting of a surface that lies adjacent to another surface that is not to be painted contemporaneously. The apparatus comprises a roller applicator, a rigid member, a brush, and a handle. Said brush is affixed to said rigid member, and said rigid member is connected to an arm that is rotatably mounted on said handle. Said arm can rotate between a paint loading position and a paint application position. In the paint loading position, said arm is moved away from said roller applicator. Said roller applicator can then be immersed in paint without getting any paint on said rigid member. When said rigid member is in the paint application position, substantially perpendicular and adjacent to the longitudinal axis of said roller applicator, said roller applicator may be placed in contact with the surface to be painted and painting may begin. Said brush of predetermined size, shape, and stiffness is mounted onto said paint roller apparatus such that the bristles, or other paint application portion of said brush, are at a non-orthogonal angle to the surface to be painted and extend to an edge of the surface to be painted, but not onto the adjacent surface. Said brush is positioned such that its paint application area partially overlaps said roller applicator paint application area. This positioning allows said brush to be filled with paint as it follows in the wet paint recently applied by said roller applicator on the surface. In operation, said roller applicator applies paint up to a short distance from the edge of the surface to be painted and said brush then takes some of the paint on the surface and applies it up to the edge.

### CROSS REFERENCE TO RELATED APPLICATIONS

This application is a continuation-in-part that claims priority of U.S. patent application Ser. No. 10/126,157 filed on Apr. 20, 2002 entitled “Paint Roller Apparatus with Edging Shield and Brush”, and U.S. patent application Ser. No. 10/271,456 filed on Oct. 15, 2002 entitled “Paint Roller Apparatus with Bar and Brush”.

### BACKGROUND—FIELD OF INVENTION

The present invention relates generally to the field of painting, A labor-intensive and time-consuming aspect of painting is the job of “edging”, a term commonly used in the field to refer to the application of paint to the edge of one surface, but not onto an adjacent surface at the point where two surfaces meet. Edging is often a required aspect of painting around doorframes, window frames, baseboards, and where a ceiling meets walls.

### BACKGROUND—DESCRIPTION OF PRIOR ART

The most common methods of edging are by either masking off areas that are to be unpainted with masking tape, thus protecting them from the application of paint during the painting process, or by using a paint brush to “cut” a straight line around unpainted surfaces. Both of these methods are very time-consuming and labor-intensive. A device that reduces the amount of time to accurately apply paint up to the edge of one surface, but not onto an adjacent surface, would be extremely desirable.

A number of prior devices have been developed in an effort to reduce the labor-intensive burden of the edging process. One such apparatus is illustrated in the Anderson patent, U.S. Pat. No. 3,623,180. The Anderson device includes a plate that mounts directly onto the roller mechanism and which acts as a shield to prevent the application of paint to an adjacent edge. One edge of the Anderson shield is straight; the straight edge of the shield is pressed flush against the painted surface during the painting process, and the paint shield rotates as necessary to keep the shield flush against the wall while the roller applicator (known in the art as a roller cover or roller sock) applies paint.

The limitation of the Anderson device is that the shield prevents the roller applicator from applying paint all the way to the adjacent edge. After a single pass, the Anderson device leaves a noticeable unpainted line around adjacent edges on the surface intended to be painted. A further problem is that repeated passes of the Anderson device cause paint to spread and seep under the paint shield and inadvertently smear on the adjacent unpainted surface.

The Deck patent, U.S. Pat. No. 3,369,269, is a similar device developed in recognition of the need to direct and control the application of paint all the way to the edge of the painted surface, including the area under the bottom edge of the shield. The Deck apparatus utilizes a thin line of bristles that are sandwiched between two shield plates and protrude beyond the bottom edges of the shield plates and are configured in a narrow line approximately the same width as the thickness of the shield. The Deck apparatus also utilizes a handle with two arms, one of which attaches to a roller applicator, and another that attaches to a shield.

One limitation of the Deck apparatus is due to the placement of the bristles. Since the bristles protrude directly from and along an edge of the shield, the length of the bristles has to be short. Short bristles lack the flexibility that longer bristles have, and the lack of flexibility hinders the smooth and controlled application of paint. Instead, the short bristles apply a noticeably thinner layer of paint near the edge that repeated passes of the device do not rectify. Another limitation is that, like the Anderson patent, the shield blocks paint from getting to the edge of the surface to be painted. Furthermore, since the brush is composed of a thin line of bristles running parallel to the plane of the shield plate, the bristles' path does not overlap that of the roller therefore making it difficult to transfer enough paint to the edge of the surface to be painted. Another limitation is that since the bristles are attached to the bottom edge of the paint shield, they prevent the shield edge from sitting flush with the wall surface thereby facilitating uncontrolled paint seepage under the shield to the adjacent surface.

Another apparatus is illustrated in the Burns patent, U.S. Pat. No. 5,623,740. The Burns device, like the Anderson device, utilizes a two-armed handle in which one arm attaches to the roller applicator and the other arm attaches to the shield. The Burns device includes a means by which the roller applicator can either be rotated parallel to the shield in order to load the roller applicator with paint, or removed from the other portion of the handle and then reassembled. After the roller applicator is loaded with paint, it is rotated perpendicular to the shield and the shield provides some degree of protection from the unwanted application of paint on an adjacent surface. While the features of the Bums apparatus provide for more efficient “reloading” of paint than the Anderson apparatus, the Burns device has the same fundamental deficiency of the Anderson device in that the shield prevents paint from getting directly to the edge of the surface to be painted. The apparatus leaves a thin but noticeable unpainted line around adjacent edges on the surface intended to be painted, and, as with the Anderson apparatus, repeated passes of the Burns apparatus causes paint to seep uncontrollably under the shield to the edge of the painted surface, and smear unintentionally on the adjacent surface. The problem of excessive seepage is practically unavoidable.

### SUMMARY

A primary object and/or advantage of the present invention is to combine the speed of a paint roller with the precision of a paint brush to apply paint quickly and accurately up to the edge of a surface without any spillover of paint onto an adjacent surface, and without the need to apply tape to the adjacent surface to protect against leakage or an accidental spillover.

It is another object and/or advantage of the present invention to make the features of the apparatus easily reversible so that the roller mechanism can paint with the brush either on the left side or the right side of the roller applicator.

It is another object and/or advantage of the present invention to eliminate the smearing of paint between a shield and an adjacent surface by eliminating the shield.

The present invention is an apparatus that is useful for painting along the edge of a surface to be painted that lies adjacent to another surface that is not to be painted contemporaneously. The invention resides in the unique configuration of a paint roller, a rigid member, a paint brush, and a handle into a single paint application apparatus. A rigid member rather than a shield is sufficient because there is no need to block paint from getting on trim or other adjacent surfaces since the roller does not need to be placed as close to the adjacent surface as in the prior art. Rather, the addition of a brush allows for a gap between the roller applicator and the adjacent surface thus eliminating the need for a shield and thereby eliminating paint smearing between the shield and the adjacent surface. The rigid member can be of any predetermined shape and size. The brush of predetermined size, shape, and stiffness is attached to the rigid member in such a way as to have unhindered access to the edge of a surface to be painted. The brush is mounted onto the rigid member at a predetermined angle such that the bristles, or other paint application portion of the brush, extend to the edge of the surface to be painted, but not onto the adjacent surface. The rigid member is rotatably affixed to an arm, which allows the apparatus to be easily used on both the left and right sides of doorframes and window frames. The arm is rotatably affixed to a handle, which allows for the easy loading of paint onto the roller applicator while protecting the rigid member and brush assembly from paint.

In operation, the roller applies the paint up to a short distance from the edge of the surface to be painted and the brush then takes some of the paint and applies it accurately to the edge unhindered by the rigid member. The roller is affixed to the handle with a separate roller arm. The arm can be rotated to a position away from the roller so that the roller can be immersed in paint without getting any paint on the rigid member, the brush, or the arm.

Other objects and/or advantages of the present invention will become apparent from a reading of the Specification and claims.

### DRAWING FIGURES

FIG. 1 is a perspective view of a first embodiment of the present invention illustrating its use in painting a wall surface adjacent a trim piece such as a doorframe, or window frame.

FIG. 2 is another perspective view similar to FIG. 1 showing the other side of the rigid member to more clearly show the rigid member and brush configuration.

FIG. 3 is another perspective view of the embodiment illustrated in FIG. 1 showing the rigid member and brush in the raised position that is used for loading paint onto the roller applicator.

FIGS. 4A and 4B further illustrate the brush configuration. FIG. 4A is a view parallel to the handle showing a brush adjustment means and FIG. 4B is a top view of the roller and brush showing their overlapping paths.

FIGS. 5A to 5C present a top view showing how the flexible projection creates space for the brush when changing the roller applicator's direction of movement.

FIG. 6 is a perspective view of showing the arm and rigid member fixed in relation to each other instead of being rotatably connected.

FIGS. 7A to 7C present side views parallel to the longitudinal axis of the roller applicator showing alternative configurations of the rigid member and brush.

FIGS. 8A and 8B are top views showing the alternative methods of rotating the arm. FIGS. 9A to 9C present top and side views showing alternative methods of rotating the roller applicator support.

FIGS. 10A to 10C show various kinds of brushes that can be used.

FIG. 11 shows a top view of the arm attached to the roller applicator support.

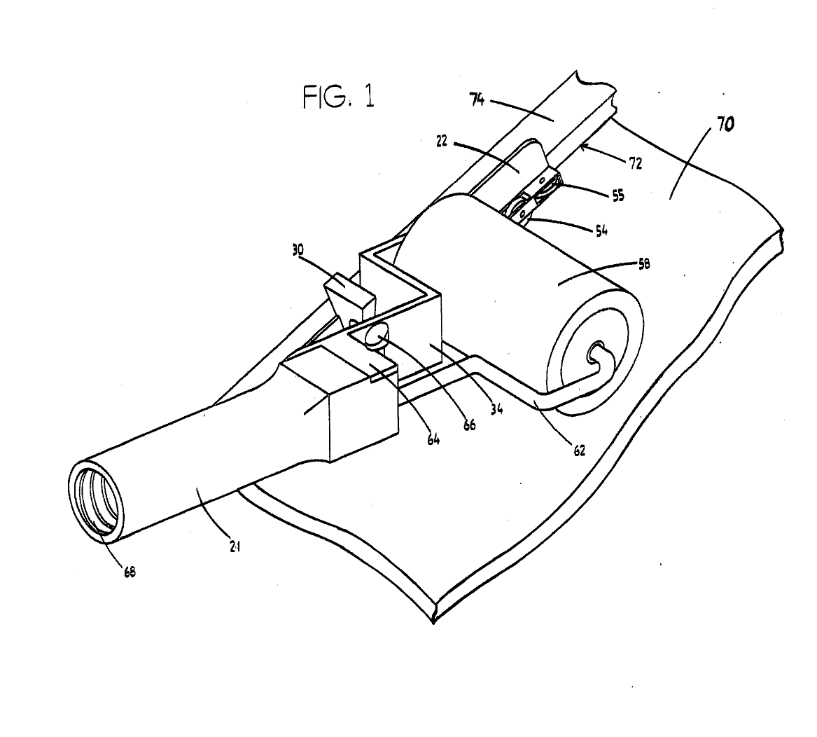

### DESCRIPTION—FIGS. 1 to 5—PREFERRED EMBODIMENT

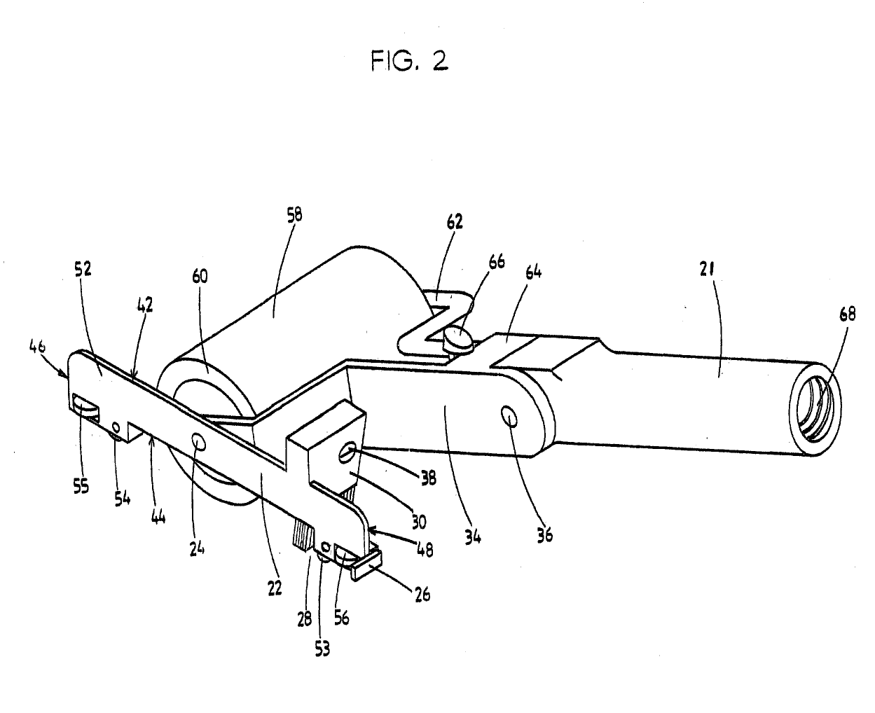

FIGS. 1 and 2 show the preferred embodiment of a painting apparatus in a paint application position comprising a handle (20), roller applicator (58), and rigid member (22) with brush (28). In the preferred embodiment, said handle has a threaded opening (68) at its base to allow a user to attach a pole if desired. In the paint application position, rigid member (22) is substantially perpendicular to roller applicator (58) and adjacent to roller applicator end (60).

FIGS. 1 to 3 also show that handle (20) comprises a handgrip (21) and a roller support (62). Handgrip (21) is supporting both roller applicator (58) and rigid member (22) by means of support arms (62) and (34) and connected respectively thereto. Roller support (62) is a round metal shaft that is bent substantially perpendicular to the longitudinal axis of handle (20). Roller support (62) is fixed with one end glued or otherwise fixed into a matching hole in handgrip (21). Roller applicator (58) is then slipped onto the unattached end of said shaft and is free to rotate about its longitudinal axis.

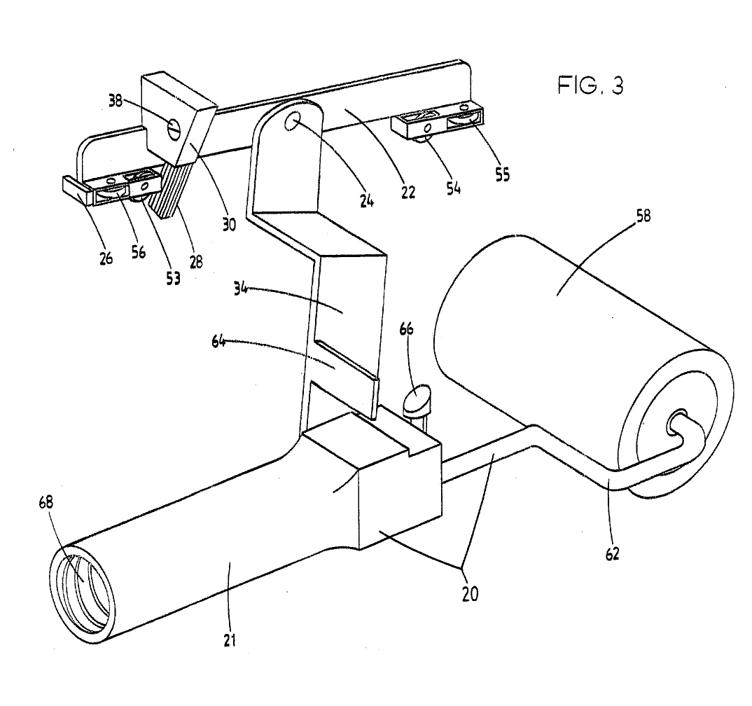

FIG. 2 shows that arm (34) is connected to handgrip (21) by means of an arm connector (36). Connector (36) allows rotation of arm (34). The axis of said rotation is substantially perpendicular to the longitudinal axis of handgrip (21) and substantially parallel to the longitudinal axis of roller applicator (58). FIGS. 1 and 2 show different views of arm (34) when it is in the paint application position. Arm (34) can then be locked in this position with a locking tab (66). FIG. 3 shows arm (34) rotated approximately 90 degrees up and away from roller applicator (58) in a paint loading position to facilitate the loading of paint thereon.

FIGS. 1 to 3 also show an arm locking means. This locking means includes a locking tab (66) that is connected on one end to handgrip (21) and is free to bend on the other end when pressure is applied to it by a user's finger or thumb. Locking tab (66) also exhibits memory such that locking tab (66) returns to its original position when said pressure is removed. A locking plate (64) is affixed to arm (34) such that in the paint application position, locking tab (66) covers locking plate (64) and prevents movement thereof. When said pressure is applied to locking tab (66), arm (34) is released and free to rotate up and away from roller applicator (58).

As shown in FIGS. 2 and 3, arm (34) is rotatably connected to rigid member (22). FIGS. 1 to 3 also show that rigid member (22) is comprised of a substantially flat, rectangular shaped plate with an inside face (50), outside face (52), front edge (46), rear edge (48), top edge (42), and bottom edge (44). Rigid member (22) is a plate approximately 0.2 centimeters thick, approximately 18 centimeters in length, and approximately 1 centimeter in height, but these measurements may vary depending on the material used for said rigid member, the size of the roller applicator used, and the requirements of the user. Furthermore, in the paint application position, said rigid member is positioned substantially parallel to and above a surface to be painted (70) such that the bottom edge of the rigid member (44) is approximately 1 centimeter above said surface to be painted. This allows the bristles of brush (28) to distribute paint under rigid member (22) all the way to an edge (72).

FIGS. 2 and 3 clearly show that rigid member (22) also has two trim wheels (55 and 56) that protrude approximately 0.3 centimeters from the outside face (52) of said rigid member. Both trim wheels (55 and 56) are located on the side of rigid member (22) with front trim wheel (55) located at front edge (46) and rear trim wheel (56) located at rear edge (48). In the paint application position, both trim wheels (55 and 56) rotate on axes that are substantially perpendicular to the plane of the surface to be painted (70) such that said trim wheels roll on an adjacent surface (74). Said trim wheels protrude from the outside face of rigid member (22) and act as guides to prevent rigid member (22) from contacting adjacent surface (74) that is not to be painted and thus prevent scraping and marking thereof and also act to position brush (28) correctly in relation to the edge of the surface to be painted (70). To prevent the bottom sides of said trim wheels from scraping the surface to be painted (70), wall wheels (53 and 54) are fixed to the bottom of rigid member (22). in the paint application position, the axis of rotation of wall wheels (53 and 54) are substantially parallel to the longitudinal axis of roller applicator (58). The combination of wall wheels (53 and 54) and trim wheels (55 and 56) creates a guide that precisely controls the distance between brush (28) and adjacent surface (74), as well as controlling the amount of flex in brush (28), thereby precisely controlling how close the bristles of said brush reach to the edge of the surface to be painted (70).

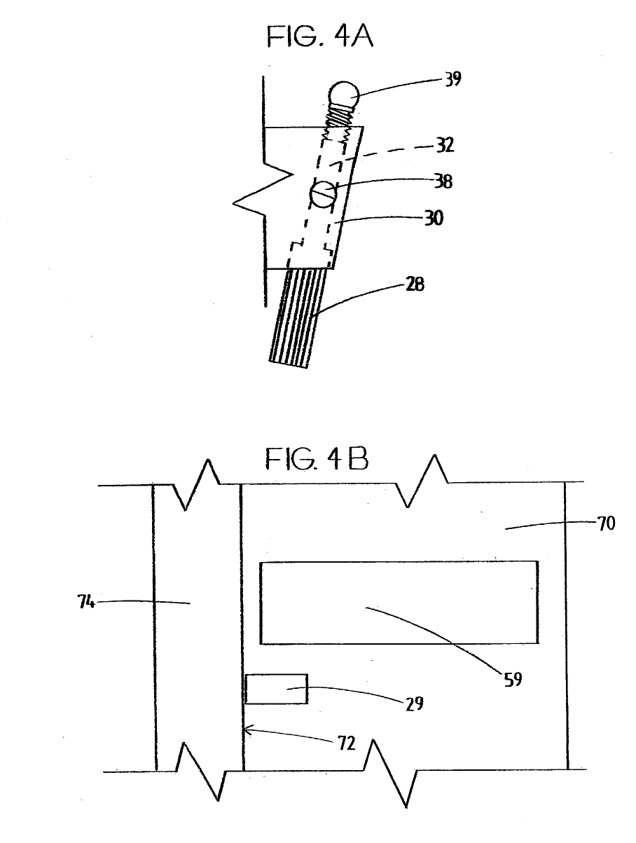

FIG. 4A shows more detail about the placement of brush (28). Said brush is mounted onto rigid member (22) at a predetermined angle such that the bristles of brush (28) are angled into the edge of the surface to be painted (72). FIG. 4B elaborates on brush's (28) position by presenting a top view of its paint application area (29), which partially overlaps the paint application area (59) of roller applicator (58) when the painting apparatus is moved forward along painting surface (70) and adjacent surface (74), thereby allowing brush (28) to partially redistribute the paint previously applied by roller applicator (58) closer to the edge of the surface to be painted (72).

FIG. 4A also shows that brush (28) has a handle (32) having a predetermined shape that slides into a matching hole on a brush holder (30) and locked into place by a locking screw (38). FIG. 4A shows with hidden lines brush handle (32) positioned in brush holder (30). Said brush can then be easily adjusted to compensate for wear of the bristles, or be removed completely for cleaning and replacement by loosening locking screw (38). Alternatively, brush handle (32) can be made to frictionally fit into brush holder (30) without the need for locking screw (38). Said brush (28) extends past bottom edge (44) of rigid member (22) a predetermined distance in order to urge a proper degree of bending in brush (28) when wall wheel (54) and roller applicator (58) are in contact with the surface to be painted (70) in the paint application position, thus allowing said brush to effectively apply paint to the edge of the surface to be painted (72). FIG. 4A shows that the distance that brush (28) extends past bottom edge (44) of rigid member (22) is adjustable with a thumbscrew (39), whereby rotation of the thumbscrew (39) raises or lowers brush (28). This feature would allow a user to adjust for wear on brush (28) as well as adjust for different surfaces to be painted (70). FIG. 4A also shows that in the preferred embodiment, brush (28) is a flat brush.

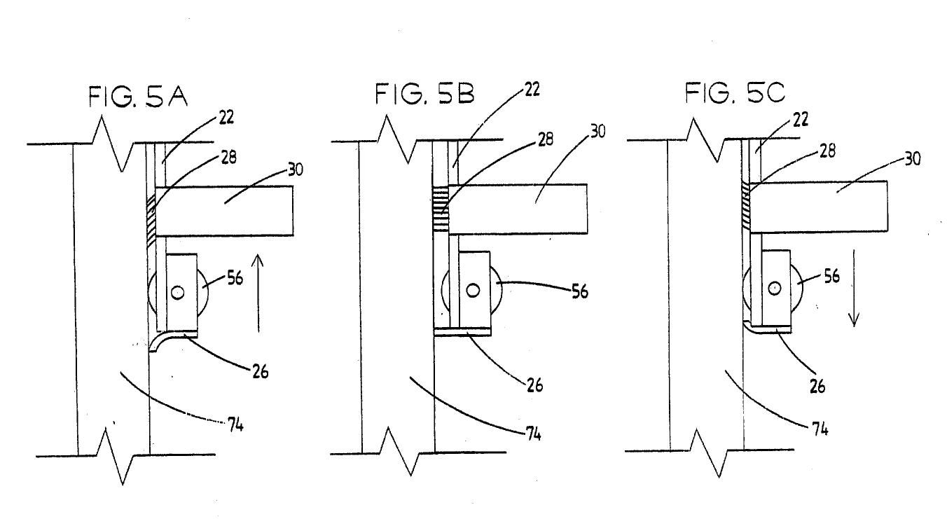

FIGS. 5A to 5C show how a flexible projection (26) creates space between brush (28) and adjacent surface (74) when the user rolls the apparatus back and forth on the surface to be painted (70). Flexible projection (26) projects past the outside face (52) of said rigid member a predetermined amount and is mounted substantially near brush (28). FIG. 5A shows how flexible projection (26) bends out of the way and lets rear trim wheel (56) contact adjacent surface (74) when the apparatus is rolled in one direction thereby allowing the flexed bristles of brush (28) to reach the edge of the surface to be painted (72). When the direction is reversed, said bristles have a natural tendency to get jammed too close to the adjacent surface (74) due to the arc-like movement of said bristles as they switch and bend in the opposite direction. FIG. 5B shows flexible projection (26) creating space between adjacent surface (74) and rigid member (22) as flexible projection (26) sweeps in an arc and thereby allowing bristles of brush (28) to sweep through an arc without getting paint on adjacent surface (74). FIG. 5C shows the completed direction change and shows brush (28) and flexible projection (26) bending in the opposite direction from FIG. 5A.

In a preferred embodiment of brush (28), the width of said brush is approximately 15 millimeters in order to move enough paint to the edge of the surface to be painted (72), but any size brush can be used as long as the required results are obtained. The preferred material for said brush is nylon or polyester, or some combination of the two. However, other materials may be used such as natural hairs, or even foam depending on the type of paint to be applied.

In the preferred embodiment, arm (34) would be constructed of a hard rigid plastic, but, clearly, any material that has sufficient strength and rigidity to support rigid member (22) can be used. Likewise, said rigid member can be made of any suitably rigid and shatter-resistant material. The preferred material would be a hard rigid plastic that meets these requirements. Alternatively, metal may be a preferred material for rigid member (22) and arm (34) for outdoor paint applications to better withstand the rigors of contacting rough exterior surfaces.

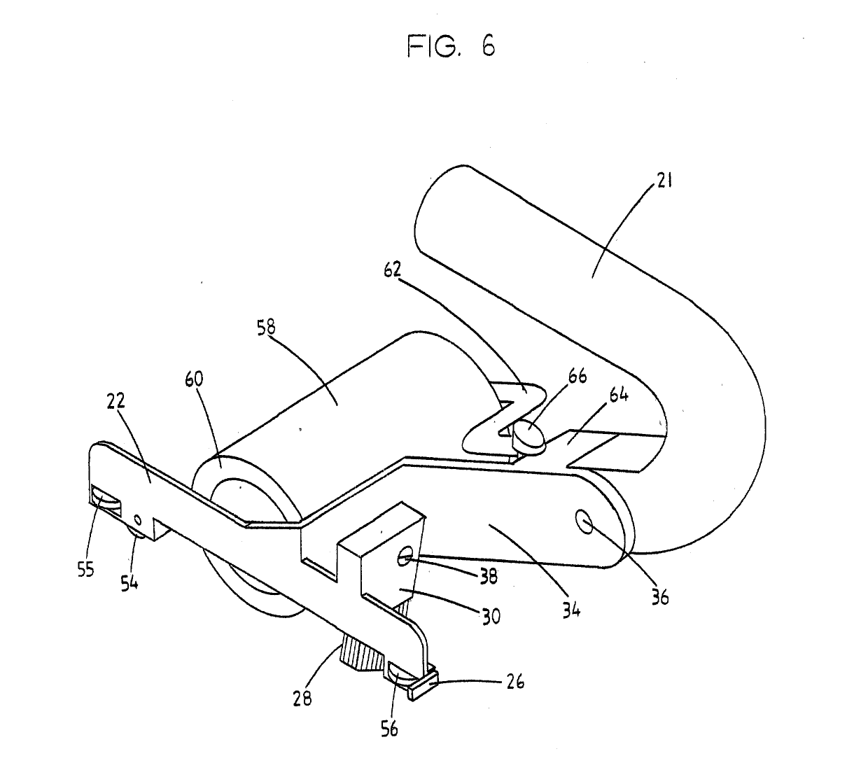

FIGS. 6 to 11—Alternative Embodiments

FIG. 6 shows that an alternative to the pivoting rigid member (22) of the preferred embodiment is a rigid member (22) that is fixed to arm (34). In this alternative embodiment, handle (20) could be bent back over roller applicator (58) to form a V or U-shaped handle (20) in order to facilitate the reversing of the apparatus to paint both sides of a doorframe, or window frame. FIG. 6 also shows that in this alternative embodiment brush (28) could be mounted on rigid member (22) or arm (34). This is feasible since rigid member (22) and arm (34) are fixed relative to each other. In fact, brush (28) could even be mounted on handle (20), if arm (34), rigid member (22), and handle (20) were all fixed relative to each other. In this case, roller applicator support (62) would rotate between a paint application position and a paint loading position instead of arm (34).

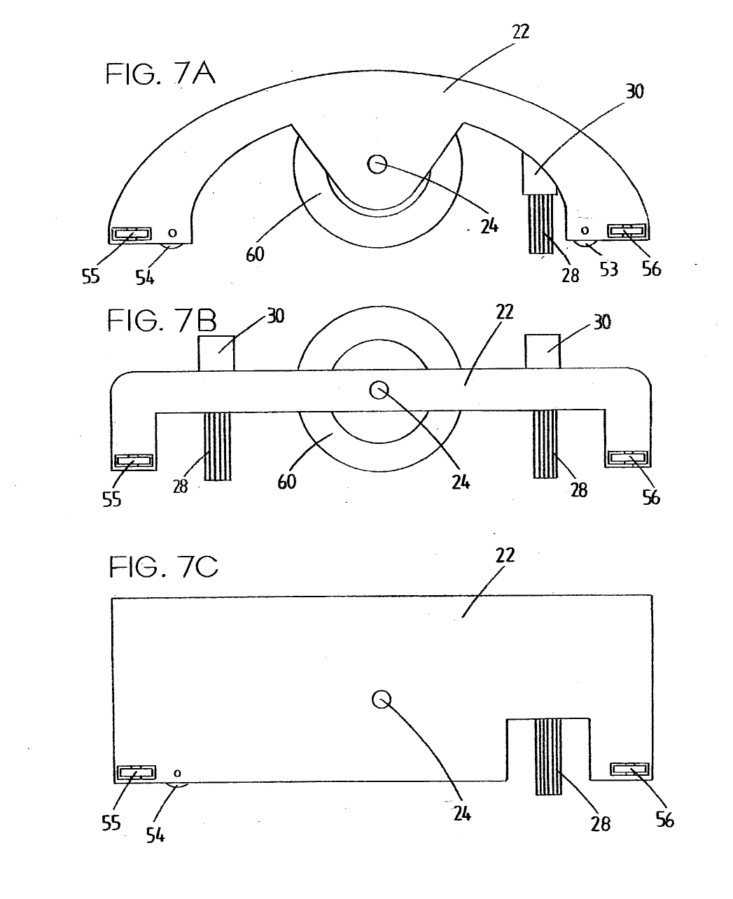

FIGS. 7A to 7C show that rigid member (22) can take many shapes other than the rectangular rigid member (22) of the preferred embodiment. FIG. 7A also shows that rigid member (22) can be curvilinear instead of straight. FIG. 7B shows that more than one brush (28) can be used in the same apparatus. FIG. 7C shows that rigid member (22) can even be stretched out into a plate or shield shape. Other shapes are clearly possible. For example, rigid member (22) can be made of a suitably stiff cylindrical shaft, which can be bent to different shapes that would work equally well as the preferred embodiment.

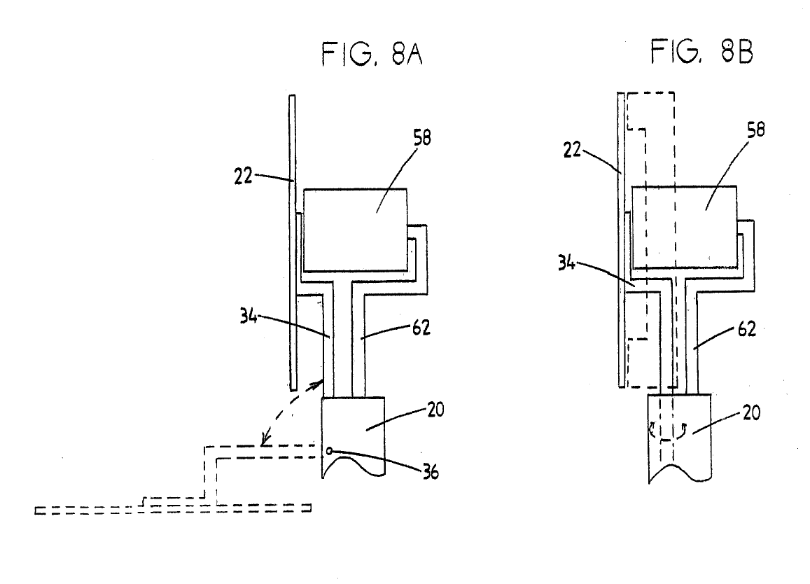

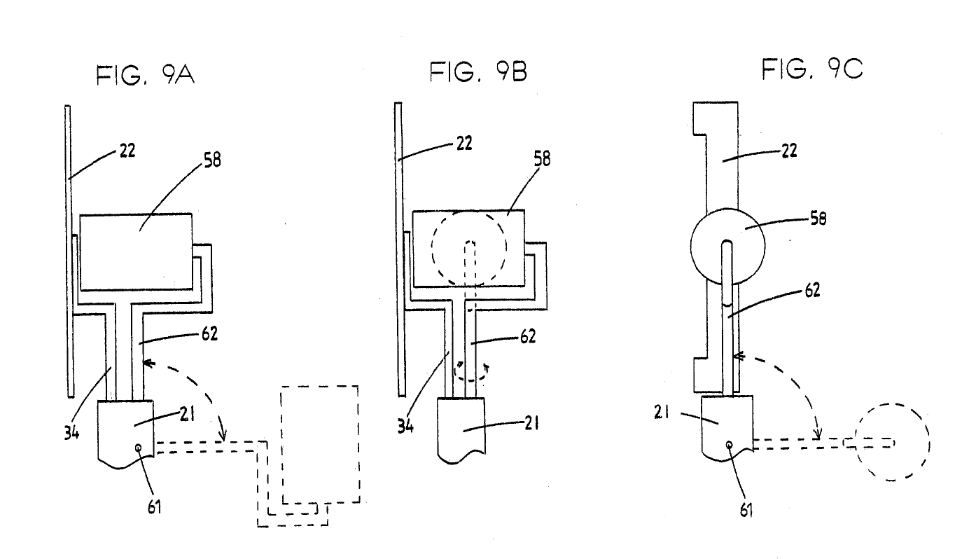

FIGS. 8A to 8B present top views of rigid member (22) and roller applicator (58) in the paint application position and show alternative embodiments that deal with various methods of rotating arm (34). FIG. 8A shows that arm (34) can be rotated on an axis substantially perpendicular to the longitudinal axis of handle (20) and substantially perpendicular to the longitudinal axis of roller applicator (58). FIG. 8B shows that arm (34) can be rotated on an axis substantially parallel to the longitudinal axis of handle (20) such that arm's (34) plane of rotation is substantially parallel to the longitudinal axis of roller applicator (58). In this embodiment, rigid member (22) and brush (28) unit rotates up and over roller applicator (58) instead of away from it as in the preferred embodiment.

FIGS. 9A to 9C show that roller support (62) can be rotated instead of arm (34) to accomplish the same purpose of creating distance between roller applicator (58) and rigid member (22) in order to facilitate the loading of paint onto roller applicator (58). There are many other ways to separate arm (34) and roller support (62) that are not expressly mentioned here, but are within the scope of the claims that follow.

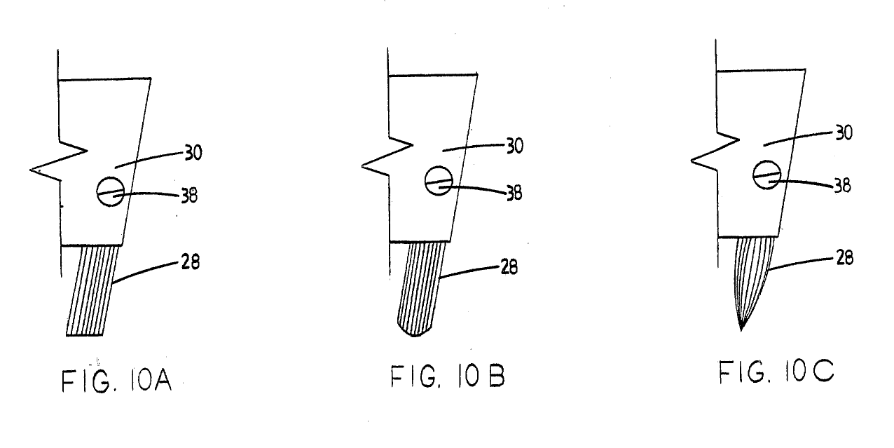

FIGS. 10A to 10C present end views perpendicular to the longitudinal axis of roller applicator (58) and show different brush shapes that can be used. FIG. 10A shows an angled brush (28) rather than the flat brush (28) of the preferred embodiment; FIG. 10B shows a flat oval shaped brush (28) known in the art as a filbert; and FIG. 10C shows a round brush (28).

Trim wheels (55 and 56) can also be replaced by non-rotating projections on the outside face of rigid member (22) that slide against the adjacent surface (74) instead of roll, in which case the tabs would be made of a non-marking material to prevent scuffing and marking on the adjacent surface. Likewise, non-rotating projections that slide against the surface to be painted (70) can replace the one or more wall wheels (53 and 54) on the bottom of rigid member (22).

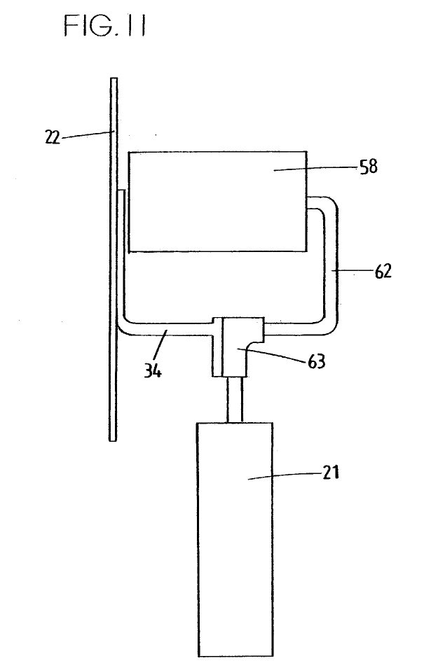

FIG. 11 shows that arm (34) can be connected to roller support (62) by means of a roller support connector (63) instead of to the handgrip (21) portion of handle (20) as in the preferred embodiment. In this embodiment, arm (34) would be rotatably connected to roller support (62) such that rigid member (22) can be moved away from roller applicator (58) to facilitate the loading of paint thereon.

Advantages

From the description above, a number of advantages of my apparatus become evident:

(a) the apparatus reduces the amount of time required to paint surface edges;

(b) the apparatus simplifies the painting process for all painters;

(c) the apparatus enables the user to paint a straighter edge than the devices of the prior art;

(d) the addition of a brush provides a means for applying paint all the way to the edge of the

surface to be painted faster than with other existing methods;

(e) the brush mounted to a rigid member provides for greater control and accuracy of the spread of paint to the edge of the surface being painted;

(f) the addition of a brush to the rigid member eliminates the need for the roller applicator to be pressed as close to the rigid member as was required in the prior art, a feature that allows the roller applicator to rotate more easily along the surface to be painted;

(g) the addition of wheels to the rigid member allows for smooth operation even on rough surfaces;

(h) the rotation of the rigid member away from the roller applicator allows for either vertical or horizontal immersion of said roller applicator into a source of wet paint without getting wet paint on the rigid member mechanism;

(i) the addition of a flexible projection on the rigid member prevents the brush from getting paint on the adjacent surface when the user changes the apparatu' direction;

(j) the elimination of a shield eliminates the problem of paint smearing between the shield and the adjacent surface; and

(k) the overlapping of paint patterns means that the brush never needs to be filled with paint because it collects paint that was recently deposited on the wall by the roller applicator, and redistributes it closer to the edge of the painting surface.

Operation—FIGS. 1 to 3

The manner of using this paint roller apparatus with rigid member and brush is similar to that for paint rollers in present use. The only difference is that the user of this apparatus has to first correctly position rigid member (22) in one of two positions: the paint application position, or the paint loading position. In the paint application position (FIGS. 1 and 2), rigid member (22) is down and substantially perpendicularly adjacent to roller applicator (58). In the paint loading position (FIG. 3), rigid member (22) is up and away from roller applicator (58). To move said rigid member from one position to the other the user has to first depress locking tab (66) away from locking platform (64) with a finger or thumb to release arm (34). Arm (34) can then be manually raised or lowered. When rigid member (22) is up, it will stay in place due to friction caused by a arm connector (36). To lower rigid member (22) into the paint application position, the user merely has to rotate arm (34) into position and locking tab (66) will automatically lock said arm in place by means of said memory exhibited by said locking tab.

To load roller applicator (58) with paint, the user has to first make sure rigid member (22) is in the paint loading position. The user can then dip roller applicator (58) into paint that is in a paint tray or a paint bucket in the traditional method. Once roller applicator (58) is sufficiently loaded with paint, arm (34) is rotated into the paint application position and locking tab (66) automatically locks said arm in place. Once rigid member (22) is in the paint application position, the painting operation can commence. To start painting, trim wheels (55, 56) are placed in contact with the adjacent surface (74) such that the longitudinal axis of roller applicator (58) is substantially perpendicular to said adjacent surface and such that wall wheels (53, 54) and roller applicator (58) contact surface to be painted (70). The apparatus is then rolled up and down the surface to be painted (70) keeping trim wheels (56) flush with adjacent surface (74). This action is continued until roller applicator (58) expends the paint and needs to be reloaded with paint. When this happens, locking tab (66) is deflected open, arm (34) is rotated out of the way, and the paint loading operation is repeated.

In operation, brush (28) never needs to be filled with paint because as roller applicator (58) applies paint to surface (70), brush (28) is filled with paint as it follows in the paint path (59) left by roller applicator (58) and redistributes the paint closer to surface edge (72) on both forward and backward rolls. The height of brush (28) is adjustable to obtain the correct amount of flex in brush (28) by turning thumbscrew (39), or other adjustment means. The more brush (28) flexes, the closer paint is applied to surface edge (72).

Conclusion, Ramifications and Scope

The roller brush apparatus of this invention can be used to significantly reduce the amount of time needed to paint the walls of a room. In addition, this apparatus greatly simplifies the process of edging such that even a novice painter can paint quickly and accurately around surfaces that are not to be painted such as doorframes and window frames. Furthermore, the roller brush apparatus has additional advantages in that:

it permits the user to paint exactly up to the edge of a surface to be painted by having a brush affixed to a rigid member adjacent to the roller applicator which applies the paint deposited by the roller applicator up to the edge without getting paint on the adjacent surface;

it eliminates the problem of paint seeping under a shield and smearing on an adjacent surface by providing a brush which eliminates the need for a shield;

it reduces the amount of time needed to trim a room by eliminating the need to tape around objects not to be painted, or trim around them with a brush; and

it permits easier rotation of the roller applicator along the surface to be painted by eliminating the need for the roller applicator to be pressed tightly against a shield, thus reducing rotating friction.

Although the description above contains many specificities, these should not be construed as limiting the scope of the invention, but as merely providing illustrations of some of the presently preferred embodiments of this invention. It is specifically stated that the present invention is not limited to any overall dimensions. For example, said roller applicator can be less than four inches long to the more conventional nine-inch length; the diameter of the roller applicator can be of any functional size; the rigid member can be trapezoidal, triangular, semi-circular, or completely curvilinear as shown in FIG. 8C; the wall wheel on the rigid member can consist of one or more wheels; the trim wheels on the rigid member can also consist of a plurality of wheels; and the thumbscrew means of raising or lowering the brush can be a cam means or other adjustment means. Furthermore, it is stated that the present invention is not limited to any material, so long as the material accomplishes the required task.

Thus the scope of the invention should be determined by the appended claims and their legal equivalents, rather than by the examples given.

What is claimed is:

1. A paint application apparatus for applying paint on a surface and up to an edge of the surface without applying paint on an adjacent surface extending from the edge, comprising:
a handle;
a roller applicator attached to said handle for rolling on and applying paint to the surface;
a rigid member attached to said handle and positioned for moving along the adjacent surface to position said roller applicator on the surface a predetermined distance from the adjacent surface;
and a paint brush attached to said paint application apparatus for applying paint on the surface up to the edge without applying paint to the adjacent surface, wherein said paint brush is positioned to partially redistribute the paint previously applied by said roller applicator closer to the surface edge.

2. The paint application apparatus of claim 1, wherein said rigid member is rotatably attached to said handle for rotating said rigid member away from said roller applicator.

3. The paint application apparatus of claim 2, wherein said rigid member is rotatably attached to said handle via an arm.

4. The paint application apparatus of claim 3, wherein said arm is rotatably attached to said handle.

5. The paint application apparatus of claim 4, wherein said rigid member is rotatably attached to said arm.

6. The paint application apparatus of claim 4, further comprising: a locking tab for releasably locking said arm to said handle and selectively preventing rotation therebetween.

7. The paint application apparatus of claim 1, wherein said roller applicator is rotatably attached to said handle for rotating said roller applicator away from said rigid member.

8. The paint application apparatus of claim 1, wherein said roller applicator is rotatably attached to said handle for rotating said roller applicator relative to said rigid member.

9. The paint application apparatus of claim 1, wherein said rigid member is fixed to said arm.

10. The paint application apparatus of claim 1, wherein said paint brush is removably attached to said paint application apparatus.

11. The paint application apparatus of claim 1, wherein said paint brush is attached to said paint application apparatus to engage with the surface at a non-orthogonal angle.

12. The paint application apparatus of claim 1, wherein said handle comprises a handgrip and a roller support.

13. The paint application apparatus of claim 1, further comprising: a flexible protrusion extending from said rigid member for engaging with the adjacent surface and for increasing the predetermined distance between said rigid member and the adjacent surface as a sliding direction therebetween is reversed.

14. The paint application apparatus of claim 1, wherein said rigid member includes one or more projections for sliding along the adjacent surface.

15. The paint application apparatus of claim 1, wherein said rigid member includes one or more wheels for rolling along the adjacent surface.

16. The paint application apparatus of claim 1, wherein said rigid member includes one or more wheels for rolling along surface.
